(19) United States
(12) Patent Application Publication
(10) Pub. No.: US 2026/0190066 A1
(43) Pub. Date: Jul. 2, 2026

(54) RANGING/SIDELINK POSITIONING METHOD AND ELECTRONIC DEVICE

(71) Applicant: BEIJING XIAOMI MOBILE SOFTWARE CO., LTD., Beijing (CN)

(72) Inventors: Yang SHEN, Beijing (CN); Jianning LIU, Beijing (CN); Haoran LIANG, Beijing (CN)

(73) Assignee: BEIJING XIAOMI MOBILE SOFTWARE CO., LTD., Beijing (CN)

(21) Appl. No.: 18/863,492

(22) PCT Filed: May 6, 2022
(86) PCT No.: PCT/CN2022/091316

§ 371 Date: Nov. 6, 2024

(51) Int. Cl. H04W 64/00; H04W 72/25

(52) U.S. Cl. CPC H04W 64/00; H04W 72/25

(57) ABSTRACT

The present disclosure provides a ranging/sidelink positioning method and an electronic device. In the method, the first terminal broadcasts a first ranging/sidelink positioning request including first indication information. The first indication information indicates that an assistant terminal is allowed to participate in ranging/sidelink positioning between the first terminal and a second terminal.

### CROSS-REFERENCE TO RELATED APPLICATIONS

The present application is a U.S. National Stage of International Application No. PCT/CN2022/091316 filed on May 6, 2022, the entire contents of which are incorporated herein by reference for all purposes.

### TECHNICAL FIELD

The present disclosure relates to the field of communication technology, and more specifically, to a ranging/sidelink positioning method, a terminal, an electronic device, and a storage medium.

### BACKGROUND

Ranging refers to the determination of the distance between two or more user equipments (UEs) and/or the direction and/or relative positioning of one UE (i.e., a target UE) from another UE (i.e., a reference UE) via PC5 interface. Sidelink positioning refers to positioning of UE using the PC5 interface.

Ranging-based services and sidelink positioning includes distance measurement and/or direction measurement, and the UE is allowed to request the distance measurement and/or the direction measurement in the service.

The related art only supports direct ranging/sidelink positioning between a reference UE and a target UE.

### SUMMARY

Embodiments of the present disclosure provide a ranging/sidelink positioning method, a device, an electronic device, and a computer-readable storage medium.

An aspect of embodiments of the present disclosure provides a ranging/sidelink positioning method, including:
broadcasting a first ranging/sidelink positioning request, the first ranging/sidelink positioning request including first indication information,
wherein the first indication information is configured to indicate that an assistant terminal is allowed to participate in ranging/sidelink positioning between a first terminal and a second terminal.

Another aspect of embodiments of the present disclosure provides a ranging/sidelink positioning method, including:
receiving a first ranging/sidelink positioning request sent by a first terminal; and
determining to act as a candidate to participate in ranging/sidelink positioning between the first terminal and a second terminal based on predetermined authorization information indicating a third terminal to act as a candidate assistant terminal, and first indication information in the first ranging/sidelink positioning request.

Another aspect of embodiments of the present disclosure provides a first terminal, including:
a first request sending module, configured to broadcast a first ranging/sidelink positioning request, the first ranging/sidelink positioning request including first indication information,
wherein the first indication information is configured to indicate that an assistant terminal is allowed to participate in ranging/sidelink positioning between the first terminal and a second terminal.

Another aspect of embodiments of the present disclosure provides a third terminal, including:
a first request receiving module, configured to receive a first ranging/sidelink positioning request broadcast by a first terminal; and
a candidate participating module, configured to determine to act as a candidate to participate in ranging/sidelink positioning between the first terminal and a second terminal based on predetermined authorization information indicating the third terminal to act as a candidate assistant terminal, and first indication information in the first ranging/sidelink positioning request.

Another aspect of embodiments of the present disclosure provides an electronic device including a memory, a processor and a computer program stored on the memory, and the processor executes the computer program to implement the steps of the method described above.

Further another aspect of embodiments of the present disclosure provides a computer-readable storage medium having a computer program stored thereon, and the computer program is executed by the processor to implement the steps of the method described above.

Additional aspects and advantages of embodiments of the present disclosure will be given in part in the following description, and in part, will become apparent from the following description or learned through the practice of the present disclosure.

### BRIEF DESCRIPTION OF THE DRAWINGS

In order to more clearly illustrate the technical solutions in embodiments of the present disclosure, the accompanying drawings used in the description of the embodiments of the present disclosure will be briefly described below.

FIG. 1 illustrates a flow diagram of a ranging/sidelink positioning method at a first terminal side provided by an embodiment of the present disclosure;

FIG. 2 illustrates a flow diagram of a ranging/sidelink positioning method at a third terminal side provided by an embodiment of the present disclosure;

FIG. 3 illustrates a schematic diagram of a structure of a first terminal provided by an embodiment of the present disclosure;

FIG. 4 illustrates a schematic diagram of a structure of a third terminal provided by an embodiment of the present disclosure;

FIG. 5 illustrates an interaction schematic diagram of a ranging/sidelink positioning provided by an embodiment of the present disclosure; and

FIG. 6 illustrates a schematic diagram of a structure of an electronic device provided by an embodiment of the present disclosure.

### DETAILED DESCRIPTION

Embodiments of the present disclosure are described below in conjunction with the accompanying drawings in the present disclosure. It is to be understood that the implementations set forth below in conjunction with the accompanying drawings are descriptions for explaining the technical solutions of the embodiments of the present disclosure, and do not constitute a limitation on the technical solutions of the embodiments of the present disclosure.

A person skilled in the art may understand that the singular forms “a”, “an”, and “the” as used herein may also include plural forms unless specifically stated. It is to be further understood that the terms “including” and “comprising” as used in the embodiments of the present disclosure mean that the corresponding features may be implemented as the features, information, data, steps, operations, elements and/or components presented, but do not preclude the implementation as other features, information, data, operations, elements, components and/or combination thereof supported in the related art. It is to be understood that when one element is referred to be “connected” or “coupled” to another element, the one element may be directly connected or coupled to the other element, or the one element may establish a connection relationship with the other element through an intermediate element. In addition, the terms “connect” or “couple” as used herein may include wireless connecting or wireless coupling. The term “and/or” as used herein indicates at least one of items defined by the term, e.g., “A and/or B” may be implemented as “A”, or as “B”, or as “A and B”.

In order to make the objects, technical solutions and advantages of the present disclosure clearer, the implementations of the present disclosure will be described in further detail in the following in conjunction with the accompanying drawings.

The present disclosure provides a ranging/sidelink positioning method, a device, an electronic apparatus, a computer-readable storage media, and a computer program product in order to solve the technical problem in the related art as described above.

The method and device are based on the same inventive concept. Since the method and device solve the problem based on similar principles, the implementations of the device and method may be referred to each other, and the repetitions will not be further described.

In addition, the technical solutions provided by the embodiments of the present disclosure may be applicable to a variety of systems, in particular, a 5G system. For example, the applicable systems may be a Global System Of Mobile Communication (GSM) system, a Code Division Multiple Access (CDMA) system, a Wideband Code Division Multiple Access (WCDMA) system, a General Packet Radio Service (GPRS) system, a Long Term Evolution (LTE) system, a LTE Frequency Division Duplex (FDD) system, a LTE Time Division Duplex (FDD) system, a Long Term Evolution Advanced (LTE-A) system, a Universal Mobile Telecommunication System (UMTS), a Worldwide Interoperability For Microwave Access (WiMAX) system, a 5G New Radio (NR) system, and so on. These various systems all include a terminal device and a network device. The system may also include a core network part, such as an Evolved Packet System (EPS), a 5G system (5GS), and the like.

The terminal (device) involved in the embodiments of the present disclosure may be a device that provides voice and/or data connectivity to a user, a handheld device with wireless connectivity, or other processing devices connected to a wireless modem, and the like. The name of the terminal device may also vary in different systems, e.g., in the 5G system, the terminal device may be referred to as a user equipment (UE). The wireless terminal device may communicate with one or more core networks (CNs) via a radio access network (RAN), and the wireless terminal device may be a mobile terminal device such as a mobile phone (or “cellular” phone) and a computer having a mobile terminal device, for example, a portable, pocket-sized, hand-held, computer-integrated, or vehicle-mounted mobile device, which exchange language and/or data with the wireless access network. Examples include devices such as Personal Communication Service (PCS) phone, cordless phone, Session Initiated Protocol (SIP) phone, Wireless Local Loop (WLL) station, Personal Digital Assistant (PDA), and the like. The wireless terminal device may also be referred to as system, subscriber unit, subscriber station, mobile station, mobile, remote station, access point, remote terminal, access terminal, user terminal, user agent, user device, which is not specifically limited in the embodiments of the present disclosure.

The technical solutions of the embodiments of the present disclosure and the technical effects produced by the technical solutions of the present disclosure are described below by describing several implementations. It is to be noted that the following implementations may be referred to, learned from or combined with each other, and the same terms, similar features, similar implementation steps or the like in different implementations will not be described repeatedly.

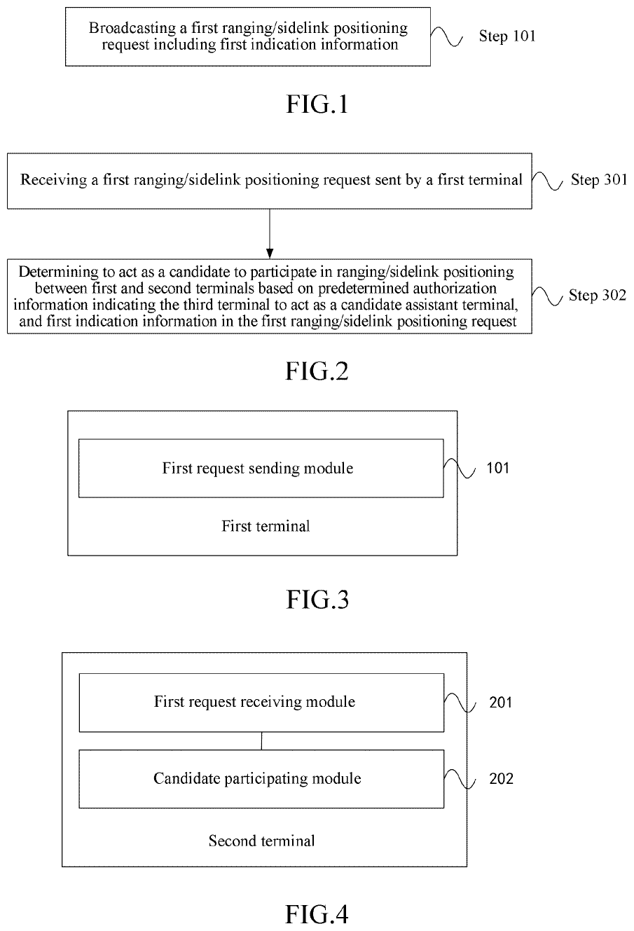

An embodiment of the present disclosure provides a ranging/sidelink positioning method at a first terminal side, as shown in FIG. 1, which includes:
step 101, broadcasting a first ranging/sidelink positioning request, the first ranging/sidelink positioning request including first indication information;
wherein the first indication information is configured to indicate that an assistant terminal is allowed to participate in ranging/sidelink positioning between the first terminal and a second terminal.

In an embodiment, the first ranging/sidelink positioning request of the present disclosure may include a unique identifier of the first terminal, a unique identifier of the second terminal, a specific service content, and the first indication information.

In another embodiment, at least one of the unique identifier of the first terminal, the unique identifier of the second terminal, the specific service content may also be recorded in the first indication information.

In an embodiment of the present disclosure, the first terminal may be a reference UE. The second terminal may be a target UE. The first terminal may broadcast the first ranging/sidelink positioning request in a current public land mobile network (PLMN), such that all other terminals in the current PLMN may receive the first ranging/sidelink positioning request.

The specific service content may be a ranging service such as a service requesting to determine a distance between the first terminal and the second terminal; a sidelink positioning service such as a service requesting positioning (e.g., to determine a direction and/or a relative positioning) between the first terminal and the second terminal; or both the ranging service and the sidelink positioning service, which is not specifically limited in the present disclosure.

In some embodiments, the first ranging/sidelink positioning request may include a Quality of Service (QOS) requirement, which refers to performance indexes such as accuracy, latency of the ranging/sidelink positioning or the like.

In the present disclosure, the assistant terminal has the capability of acting as an assistant terminal to participate in the ranging/sidelink positioning between the two terminals.

In an embodiment, the assistant terminal may be communicatively connected to the two terminals respectively, and initiate the ranging/sidelink positioning to the first terminal and the second terminal respectively, so that the first terminal may respond to the ranging/sidelink positioning result between the first terminal and the second terminal, and it is to be understood that the ranging/sidelink positioning between the first terminal and the second terminal is obtained based on the ranging/sidelink positioning between the assistant terminal and the first terminal and that between the assistant terminal and the second terminal respectively.

In an embodiment of the present disclosure, the first indication information is provided in the first ranging/sidelink positioning request to inform other terminals in the current PLMN that it is acceptable to perform the ranging/sidelink positioning with the participation of another terminal (e.g., an assistant terminal), and when the first terminal and the second terminal cannot be directly connected to each other, the ranging/sidelink positioning between the first terminal and the second terminal is performed with the participation of the assistant terminal.

In the ranging/sidelink positioning method provided by the present disclosure, as the first ranging/sidelink positioning request is broadcast, the first ranging/sidelink positioning request includes the first indication information, and the first indication information is configured to indicate that the assistant terminal is allowed to participate in ranging/sidelink positioning between the first terminal and the second terminal, the problem in which the ranging/sidelink positioning between two terminals cannot be performed when the two terminals cannot be directly connected with each other is overcome, and it enables ranging/sidelink positioning with a lightweight signaling.

In an embodiment, the first terminal broadcasts the first ranging/sidelink positioning request, the first ranging/sidelink positioning request includes the first indication information, the first indication information is configured to indicate that the assistant terminal is allowed to participate in the ranging/sidelink positioning between the first terminal and the second terminal, and if the assistant terminal in the current PLMN receives the first ranging/sidelink positioning request, the assistant terminal may send response information to the first terminal to indicate that it has the capability of acting as the assistant terminal to participate in the ranging/sidelink positioning between the first terminal and the second terminal. The first terminal uses the assistant terminal to perform the ranging/sidelink positioning between the first terminal and the second terminal.

In an embodiment, the first indication information is configured to instruct a candidate assistant terminal to return first response information to the first terminal based on having discovered the second terminal.

The candidate assistant terminal is a terminal having the capability of acting as the assistant terminal to participate in ranging/sidelink positioning between two terminals, but is not determined to participate in the ranging/sidelink positioning between the first terminal and the second terminal.

The candidate assistant terminal discovers the second terminal based on receiving the first indication information and returns the first response information to the first terminal upon discovery of the second terminal, and the first response information may be configured to indicate that the candidate assistant terminal itself has discovered the second terminal.

In an embodiment, the candidate assistant terminal may directly discover the second terminal (Direct Discovery).

In an embodiment, the candidate assistant terminal may be connected to the second terminal via the PC5 interface when discovering the second terminal.

In an embodiment, the ranging/sidelink positioning method includes:
step 201, sending a second ranging/sidelink positioning request to at least one assistant terminal.

In an embodiment of the present disclosure, the at least one assistant terminal is determined from at least one candidate assistant terminal based on receiving the first response information from the at least one candidate assistant terminal.

The determined assistant terminal will participate in the ranging/sidelink positioning between the first terminal and the second terminal. The number of the determined assistant terminals is not specifically limited in the embodiments of the present disclosure, for example, it may be one or more.

The method of determining the assistant terminal from the candidate assistant terminals is not specifically limited in the embodiment of the present disclosure. In an embodiment, the assistant terminal may be determined according to the sequent which the respective candidate assistant terminals send the first response information. A faster response of the candidate assistant terminal tends to indicate that a closer distance from the candidate assistant to the first terminal and/or the second terminal or a higher communication quality thereof, and thus the ranging/sidelink positioning with the participation of the assistant terminal determined according to the sequence is also more accurate.

In an embodiment, the embodiment of the present disclosure uses the candidate assistant terminal corresponding to the first response information firstly received as the assistant terminal.

In an embodiment, when there are a plurality of assistant terminals, the first terminal may use each of the assistant terminals to perform the ranging/sidelink positioning with the second terminal. In an example where the assistant terminals include an assistant terminal 1 and an assistant terminal 2, the first terminal and the second terminal respectively perform ranging/sidelink positioning with the assistant terminal 1 to obtain measurement information; and the first terminal and the second terminal respectively perform ranging/sidelink positioning with the assistant terminal 2 to obtain measurement information. The measurement information is shared among the first terminal, the second terminal, the assistant terminal 1 and the assistant terminal 2 via the assistant terminal 1 and the assistant terminal 2, and one terminal among the first terminal, the second terminal, the assistant terminal 1 and the assistant terminal 2 obtains all the measurement information, and then performs a calculation for the result and sends the result to the first terminal.

In an embodiment of the present disclosure, the second ranging/sidelink positioning request includes second indication information, and the second indication information is configured to authorize the candidate assistant terminal as the assistant terminal to participate in the ranging/sidelink positioning between the first terminal and the second terminal. By sending the second ranging/sidelink positioning request to the assistant terminal, only the assistant terminal that has been screened by the first terminal can participate in the ranging/sidelink positioning, which improves the autonomy of the first terminal.

On the basis of the above embodiments, in an embodiment, the second indication information is further configured to instruct the assistant terminal to perform ranging/sidelink positioning with the first terminal, to initiate ranging/sidelink positioning to the second terminal, to perform the ranging/sidelink positioning with the second terminal, and to act as a relay for communication between the first terminal and the second terminal to enable ranging/sidelink positioning measurement data and a ranging/sidelink positioning result to be shared.

In an embodiment, the second indication information may include identifiers of the first terminal, the second terminal and the assistant terminal to indicate a role of the three terminals in the ranging/sidelink positioning process.

In another embodiment, the second indication information may include a unique identifier of the second terminal to indicate that the ranging/sidelink positioning is for the first terminal and the second terminal, so as to enable the assistant terminal to be aware of the responsibility thereof, i.e., performing the ranging/sidelink positioning with the first terminal and the second terminal, respectively, and acting as a relay for the communication between the first terminal and the second terminal to enable ranging/sidelink positioning measurement data and a ranging/sidelink positioning result to be shared.

In the embodiment of the present disclosure, with the help of the assistant UE, the ranging/sidelink positioning is performed via lightweight signaling.

On the basis of the above embodiments, in an embodiment of the present disclosure, the assistant terminal respectively performs, based on receiving the second indication information, the ranging/sidelink positioning with the first terminal and the second terminal, and the ranging/sidelink positioning measurement data will be shared among the first terminal, the second terminal, and the assistant terminal to derive the ranging/sidelink positioning result.

An embodiment of the present disclosure further includes:
responding to the ranging/sidelink positioning result;
wherein the ranging/sidelink positioning result is determined by the first terminal, the second terminal and/or the at least one assistant terminal based on the ranging/sidelink positioning measurement data shared.

Since the ranging/sidelink positioning measurement data of the present disclosure is shared, in practice the ranging/sidelink positioning result may be generated by any one or more of the first terminal, the second terminal, and the assistant terminal based on the shared ranging/sidelink positioning measurement data, and the final ranging/sidelink positioning result will be responded to by the first terminal.

The first terminal and the second terminal respectively perform the ranging/sidelink positioning with the assistant terminal to obtain measurement information. The measurement information is shared among the first terminal, the second terminal, and the assistant terminal via the assistant terminal, and one of the first terminal, the second terminal, and the assistant terminal, for example, the assistant terminal, obtains all of the measurement information and then performs a calculation for the result and sends the result to the first terminal.

On the basis of the above embodiments, in an embodiment, the first indication information is further configured to instruct the second terminal to return second response information to the first terminal based on receiving the first ranging/sidelink positioning request.

It is to be noted that in some embodiments, the second terminal may also be a candidate assistant terminal, i.e., a terminal having the capability of acting as an assistant terminal to participate in ranging/sidelink positioning between two terminals, in which case the candidate assistant terminal returns the second response information to the first terminal, so that the first terminal may establish a direct link with the second terminal and thus perform the ranging/sidelink positioning directly with the second terminal.

In some embodiments, when the first terminal receives the second response information returned by the second terminal, it may perform the ranging/sidelink positioning with the second terminal, and at the same time, the assistant terminal may also participate in the ranging/sidelink positioning between the first terminal and the second terminal.

On the basis of the above embodiments, in an embodiment, before the first terminal sends the second ranging/sidelink positioning request to the at least one assistant terminal, it further includes:
determining the at least one assistant terminal from the at least one candidate assistant terminal based on receiving the first response information sent by the at least one candidate assistant terminal and not receiving the second response information within a predetermined time period.

In an embodiment of the present disclosure, specifically, a timer of a predetermined time period may be set, and when the timer is up, if only the first response information sent by the candidate assistant terminal is received and the second response information sent by the second terminal is not received, the first response information and the second response information are no longer received, and the at least one assistant terminal is determined from the at least one candidate assistant terminal.

The start timing of the timer is not specifically limited in the present disclosure, for example, the timer may be started when the first ranging/sidelink positioning request is broadcast, or when the first terminal receives the first response information sent by the first candidate assistant terminal.

On the basis of the above embodiments, in an embodiment, if the second response information is received within the preset time period, the ranging/sidelink positioning is initiated to the second terminal.

Before the timer is up, when the first terminal receives the second response information, it establishes a direct link with the second terminal and initiates the ranging/sidelink positioning to the second terminal.

In some embodiments, when the first terminal receives the second response information, the first terminal stops receiving the first response information sent by the candidate assistant terminal.

FIG. 2 illustrates a flow diagram of a ranging/sidelink positioning method at a third terminal side in an embodiment of the present disclosure, and as shown in FIG. 2, the method includes:
S301, receiving a first ranging/sidelink positioning request sent by a first terminal; and
S302, determining to act as a candidate to participate in ranging/sidelink positioning between the first terminal and a second terminal based on predetermined authorization information indicating the third terminal to act as a candidate assistant terminal, and first indication information in the first ranging/sidelink positioning request.

The first indication information is configured to indicate that an assistant terminal is allowed to participate in the ranging/sidelink positioning between the first terminal and the second terminal.

In an embodiment, the first ranging/sidelink positioning request of the present disclosure may include a unique identifier of the first terminal, a unique identifier of the second terminal, a specific service content, and the first indication information.

In another embodiment, at least one of the unique identifier of the first terminal, the unique identifier of the second terminal, and the specific service content may also be recorded in the first indication information.

In an embodiment of the present disclosure, the first terminal may be a reference UE. The second terminal may be a target UE. The first terminal may broadcast the first ranging/sidelink positioning request in a current public land mobile network (PLMN), such that all other terminals in the current PLMN may receive the first ranging/sidelink positioning request.

The specific service content may be a ranging service such as a service requesting to determine a distance between the first terminal and the second terminal; a sidelink positioning service such as a service requesting positioning (e.g., to determine a direction and/or a relative positioning) between the first terminal and the second terminal; or both the ranging service and the sidelink positioning service, which is not specifically limited in the present disclosure.

In an embodiment of the present disclosure, the first indication information is provided in the first ranging/sidelink positioning request to inform other terminals in the current PLMN that it is acceptable to perform the ranging/sidelink positioning with the participation of another terminal (e.g., an assistant terminal), and when the first terminal and the second terminal cannot be directly connected to each other, the ranging/sidelink positioning between the first terminal and the second terminal is performed with the participation of the assistant terminal.

The embodiment of the present disclosure is applicable to a terminal that obtains in advance an authorization to act as the candidate assistant terminal, i.e., if the third terminal, upon receiving the first ranging/sidelink positioning request from the first terminal, determines in advance that it is authorized as the candidate assistant terminal, the third terminal determines to act as the candidate to participate in the ranging/sidelink positioning between the first terminal and the second terminal based on the first indication information in the first ranging/sidelink positioning request.

A terminal may act as the candidate to participate in the ranging/sidelink positioning between the first terminal and the second terminal, which means that it has the capability of acting as the assistant terminal to participate in the ranging/sidelink positioning between the two terminals and has the opportunity to participate in the ranging/sidelink positioning between the first terminal and the second terminal.

In the ranging/sidelink positioning method at the third terminal side of the present disclosure, the first ranging/sidelink positioning request broadcast by the first terminal is received, and based on the first indication information in the request and the predetermined authorization information indicating the third terminal to act as the candidate assistant terminal, it determines, with just a lightweight signaling, to act as the candidate to participate in the ranging/sidelink positioning between the first terminal and the second terminal, therefore the problem in which the ranging/sidelink positioning between two terminals cannot be performed when the two terminals cannot be directly connected with each other is overcome.

On the basis of the above embodiments, in an embodiment, when it determines to act as the candidate to participate in the ranging/sidelink positioning between the first terminal and the second terminal, the ranging/sidelink positioning method at the third terminal side further includes:
returning first response information to the first terminal based on having discovered the second terminal.

In an embodiment of the present disclosure, after determining to act as the candidate to participate in the ranging/sidelink positioning between the first terminal and the second terminal, the third terminal may initiate a process of discovering the second terminal, thereby returning the first response information to the first terminal when discovering the second terminal.

In some embodiments, the first response information is configured to indicate that the third terminal has discovered the second terminal.

In the embodiment of the present disclosure, returning the first response information to the first termina enables the first terminal to determine that the ranging/sidelink positioning with respect to the second terminal may be performed by using another terminal as the assistant terminal.

In some embodiments, the third terminal may establish a PC5 connection with the second terminal upon the discovery of the second terminal.

On the basis of the above embodiments, in an embodiment, if the second terminal of the embodiment of the present disclosure determines that the second terminal searched for by the first terminal is itself based on the first ranging/sidelink positioning request, it returns second response information to the first terminal, and the second response information is configured to indicate that it is the second terminal. By returning the second response information, the first terminal is enabled to determine that it has discovered the second terminal, and then the first terminal can establish a direct link with the second terminal, and the first terminal can directly initiate the ranging/sidelink positioning to the second terminal after establishing the direct link with the second terminal.

On the basis of the above embodiments, in an embodiment, the ranging/sidelink positioning method at the third terminal side further includes:
S401, receiving a second ranging/sidelink positioning request sent by the first terminal, and determining to participate in the ranging/sidelink positioning between the first terminal and the second terminal based on second indication information in the second ranging/sidelink positioning request.

When the first terminal sends the second ranging/sidelink positioning request to the third terminal, it indicates that the first terminal determines to use the third terminal as a network relay to participate in the ranging/sidelink positioning between the first terminal and the second terminal (specifically for the sharing of ranging/sidelink positioning measurement data).

The second ranging/sidelink positioning request includes the second indication information, and the second indication information is configured to authorize the third terminal as the assistant terminal to participate in the positioning between the first and second terminals. By sending the second ranging/sidelink positioning request to the assistant terminal, it enables only the assistant terminal that has been screened by the first terminal to participate in the ranging/sidelink positioning, which improves the autonomy of the first terminal.

In some embodiments, the third terminal may establish a PC5 connection with the second terminal when it determines to participate in the positioning, i.e., when it receives the second ranging/sidelink positioning request.

On the basis of the above embodiments, in an embodiment, the second indication information is further configured to instruct the assistant terminal to initiate ranging/sidelink positioning to the second terminal and to act as a relay for communication between the first terminal and the second terminal to enable the ranging/sidelink positioning measurement data to be shared.

The ranging/sidelink positioning method at the third terminal side further includes:
based on the second indication information, performing ranging/sidelink positioning with the first terminal, initiating ranging/sidelink positioning to the second terminal, performing the ranging/sidelink positioning with the second terminal, and acting as a relay for communication between the first terminal and the second terminal to enable ranging/sidelink positioning measurement data and a ranging/sidelink positioning result to be shared.

In an embodiment, the second indication information may include identifiers of the first terminal, the second terminal and the assistant terminal to indicate a role of the three terminals in the ranging/sidelink positioning process.

In another embodiment, the second indication information may include a unique identifier of the second terminal to indicate that the ranging/sidelink positioning is for the first terminal and the second terminal, so as to enable the assistant terminal to be aware of the responsibility thereof, i.e., performing the ranging/sidelink positioning with the first terminal and the second terminal, respectively, and acting as a relay for the communication between the first terminal and the second terminal.

On the basis of the above embodiments, the third terminal initiates the ranging/sidelink positioning to the second terminal, which includes:
sending a third ranging/sidelink positioning request to the second terminal, the third ranging/sidelink positioning request including the second indication information.

Since the second indication information is configured to indicate to operate an assistant terminal to participate in the ranging/sidelink positioning between the first terminal and the second terminal, when receiving the third ranging/sidelink positioning request, the second terminal may be informed that the third terminal is used as the assistant terminal of the first terminal and the second terminal to participate in the ranging/sidelink positioning between the first terminal and the second terminal, and thus the second terminal may perform the ranging/sidelink positioning with the third terminal, and receive the ranging/sidelink positioning measurement data of the third terminal, or receive the ranging/sidelink positioning measurement data and/or the ranging/sidelink positioning result from the first terminal via the third terminal, and may also share the ranging/sidelink positioning measurement data and the ranging/sidelink positioning result generated by itself (if the result is determined by the second terminal) with the third terminal or share the same with the first terminal via the third terminal.

On the basis of the above embodiments, in an embodiment, an embodiment of the present disclosure further includes:
determining that the second terminal has been discovered based on having searched the second terminal in a maintained list of terminals.

In the present disclosure, the second terminal is discovered in a manner of searching the second terminal in a locally maintained list of terminals. If a unique identifier of the second terminal exists in the list of terminals, it determines that the second terminal has been discovered, and if the unique identifier of the second terminal is not found in the list of terminals, it determines that the discovery of the second terminal has failed.

On the basis of the above embodiments, in an embodiment, the embodiment of the present disclosure further include:
triggering a process for discovering the second terminal if the second terminal has not been searched in the list of terminals; and
recording a unique identifier of the second terminal in the list of terminals when discovering the second terminal.

In an embodiment of the present disclosure, the second terminal is firstly searched in the local list of terminals, and then the process of discovering the second terminal is triggered if the second terminal is not found locally, which improves the efficiency and success rate of discovering the second terminal. The unique identifier of the second terminal is further recorded in the list of terminals after the second terminal is discovered, which provides a basis for the subsequent rapid discovery of the second terminal. It is to be understood that when the third terminal discovers the second terminal, it sends the first response information to the first terminal.

On the basis of the above embodiments, in an embodiment, before the third terminal receives the first positioning request sent by the first terminal, it further includes:
S501, sending third indication information to a policy control function entity, the third indication information being configured to indicate that the third terminal has a capability of acting as an assistant terminal to participate in ranging/sidelink positioning between two terminals; and
S502, receiving authorization information returned by the policy control function entity, the authorization information being configured to indicate that the third terminal is allowed to act as a candidate assistant terminal to perform the ranging/sidelink positioning service.

In an embodiment of the present disclosure, if the third terminal determines that it has the capability of acting as the assistant terminal to participate in the ranging/sidelink positioning between two terminals, the third terminal sends the third indication information to the policy control function entity, and if the policy control entity determines that the third terminal may act as the candidate assistant terminal at the current PLMN, time, and location, the policy control entity returns the authorization information to the third terminal, the authorization information is configured to indicate that the third terminal is allowed to act as the candidate assistant terminal to perform the ranging/sidelink positioning service.

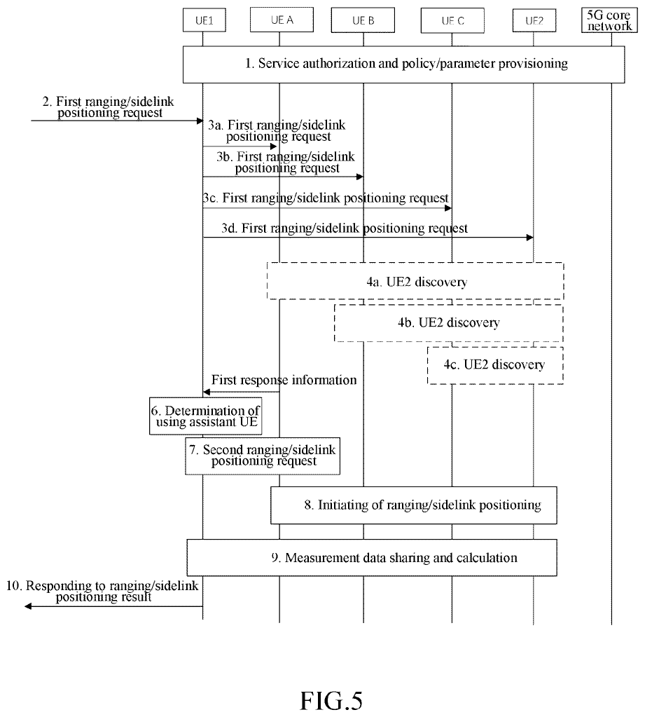

FIG. 5 illustrates an interaction schematic diagram of a ranging/sidelink positioning in an embodiment of the present disclosure, as shown in FIG. 5:
1. UE1 and UE2 are authorized as a reference UE and a target UE, respectively, for ranging/sidelink positioning at the current PLMN, time and location, and UE A, UE B and UE C are authorized as candidate assistant UEs for ranging/sidelink positioning at the current PLMN, time and location.
2. UE1 receives a ranging/sidelink positioning request from an application layer, a third party UE or a network function (NF) entity in a 5G Core network (5G Core) for ranging/sidelink positioning between UE1 and UE2.
3. UE1 broadcasts the first ranging/sidelink positioning request to UE A, UE B, and UE C. The first ranging/sidelink positioning request also has first indication information, which may include unique identifiers (IDs) of UE1 and UE2, a ranging/sidelink positioning content, and a QoS requirement, and so on.
4. When UE A, UE B, and UE C receive the first ranging/sidelink positioning request, they check whether UE2 has been discovered in the local list of terminals according to the unique identifier of UE2.
5. UE A successfully discovers UE2 and sends first response information to UE1.
6. UE1 starts the pre-configured timer when it receives the first response information from UE A. When the timer is up and UE1 still has not received the second response information sent by UE2, it determines to use UE A to perform the ranging/sidelink positioning.
7. UE1 sends a second ranging/sidelink positioning request to UE A. The second ranging/sidelink positioning request includes second indication information, and the second indication information is configured to authorize UE A as an assistant terminal to participate in the ranging/sidelink positioning between the UE1 and UE2.
8. UE A sends a third ranging/sidelink positioning request to UE2 based on receiving the second ranging/sidelink positioning request, the third ranging/sidelink positioning request including the first indication information.
9. The ranging/sidelink positioning measurement data is shared among UE1, UE2 and UE A to derive a ranging/sidelink positioning result.
10. UE1 responds to the ranging/sidelink positioning result.

An embodiment of the present disclosure provides a first terminal, and as shown in FIG. 3, the first terminal includes a first request sending module 101.

The first request sending module 101 is configured to broadcast a first ranging/sidelink positioning request, the first ranging/sidelink positioning request including first indication information,
wherein the first indication information is configured to indicate that an assistant terminal is allowed to participate in ranging/sidelink positioning between the first terminal and a second terminal.

The device of the embodiments of the present disclosure may perform the ranging/sidelink positioning method at the first device side provided by the embodiments of the present disclosure, and they have similar principles of realization. The actions performed by the modules in the first terminal of the embodiments of the present disclosure correspond to the steps in the ranging/sidelink positioning method at the first device side of the embodiments of the present disclosure, and a detailed description of the functions of the modules of the device may be specifically referred to the description in the corresponding method above and will not be repeated herein.

In an embodiment, the first indication information is further configured to instruct a candidate assistant terminal to return first response information to the first terminal based on having discovered the second terminal.

In an embodiment, the first terminal further includes:
a second request sending module, configured to send a second ranging/sidelink positioning request to at least one assistant terminal,
wherein the second ranging/sidelink positioning request includes second indication information, and the second indication information is configured to authorize the candidate assistant terminal as the assistant terminal to participate in the positioning between the first terminal and the second terminal, and
the at least one assistant terminal is determined from at least one candidate assistant terminal that returned the first response information.

In an embodiment, the second indication information is further configured to instruct the assistant terminal to perform ranging/sidelink positioning with the first terminal, to initiate ranging/sidelink positioning to the second terminal, to perform the ranging/sidelink positioning with the second terminal, and to act as a relay for communication between the first terminal and the second terminal to enable ranging/sidelink positioning measurement data and a ranging/sidelink positioning result to be shared.

In an embodiment, the first terminal further includes:
a result responding module, configured to respond to the ranging/sidelink positioning result,
wherein the ranging/sidelink positioning result is determined by the first terminal, the second terminal and/or the at least one assistant terminal based on the ranging/sidelink positioning measurement data shared.

In an embodiment, the first indication information is further configured to instruct the second terminal to return second response information to the first terminal based on receiving the first ranging/sidelink positioning request.

In an embodiment, the first terminal further includes:
an assistant terminal determining module, configured to: determine the at least one assistant terminal from the at least one candidate assistant terminal based on receiving the first response information sent by the at least one candidate assistant terminal and not receiving the second response information within a predetermined time period.

In an embodiment, the assistant terminal determining module is configured to use the candidate assistant terminal corresponding to the first response information firstly received as the assistant terminal.

In an embodiment, the first terminal further includes:
a direct link positioning module, configured to initiate ranging/sidelink positioning to the second terminal if the second response information is received within the predetermined time period.

In an embodiment, the predetermined time period is started at the time when the first ranging/sidelink positioning request is broadcast or the first response information sent by a first candidate assistant terminal is received.

An embodiment of the present disclosure provides a third terminal, and as shown in FIG. 4, the third terminal includes a first request receiving module 201 and a candidate participating module 202.

The first request receiving module 201 is configured to receive a first ranging/sidelink positioning request broadcast by a first terminal; and
the candidate participating module 202 is configured to determine to act as a candidate to participate in ranging/sidelink positioning between the first terminal and a second terminal based on predetermined authorization information indicating the third terminal to act as a candidate assistant terminal, and first indication information in the first ranging/sidelink positioning request.

The device of the embodiments of the present disclosure may perform the ranging/sidelink positioning method at the third device side provided by the embodiments of the present disclosure, and they have similar principles of realization. The actions performed by the modules in the third terminal of the embodiments of the present disclosure correspond to the steps in the ranging/sidelink positioning method at the third device side of the embodiments of the present disclosure, and a detailed description of the functions of the modules of the device may be specifically referred to the description in the corresponding method above and will not be repeated herein.

In an embodiment, the third terminal further includes:
a first responding module, configured to return first response information to the first terminal based on having discovered the second terminal.

In an embodiment, the third terminal further includes:
a second responding module, configured to determine the third terminal itself to be the second terminal, and return second response information to the first terminal.

In an embodiment, the third terminal further includes:
a second request receiving module, configured to receive a second ranging/sidelink positioning request sent by the first terminal, and determine to participate in the ranging/sidelink positioning between the first terminal and the second terminal based on second indication information in the second ranging/sidelink positioning request.

In an embodiment, the third terminal further includes:
a positioning sharing module, configured to, based on the second indication information, perform ranging/sidelink positioning with the first terminal, initiate ranging/sidelink positioning to the second terminal, perform the ranging/sidelink positioning with the second terminal, and act as a relay for communication between the first terminal and the second terminal to enable ranging/sidelink positioning measurement data and a ranging/sidelink positioning result to be shared.

In an embodiment, the positioning sharing module is further configured to send a third ranging/sidelink positioning request to the second terminal, the third ranging/sidelink positioning request includes the second indication information.

In an embodiment, the third terminal further includes:
a local list searching module, configured to determine that the second terminal has been discovered based on having searched the second terminal in a maintained list of terminals.

In an embodiment, the third terminal further includes:
a network discovering module, configured to trigger a process for discovering the second terminal based on not searching the second terminal in the list of terminals; and
a recording module, configured to record a unique identifier of the second terminal in the list of terminals when discovering the second terminal.

In an embodiment, the third terminal further includes:
a third indication discovering module, configured to send third indication information to a policy control function entity, the third indication information being configured to indicate that the third terminal has a capability of acting as an assistant terminal to participate in ranging/sidelink positioning between two terminals; and
an authorization receiving module, configured to receive authorization information returned by the policy control function entity, the authorization information being configured to indicate that the third terminal is allowed to act as a candidate assistant terminal to participate in the ranging/sidelink positioning.

An embodiment of the present disclosure provides an electronic device including a memory, a processor, and a computer program stored on the memory. The processor executes the above computer program to implement steps of a ranging/sidelink positioning method, which can implement in comparison with the related art: broadcasting a first ranging/sidelink positioning request, the first ranging/sidelink positioning request includes first indication information, and the first indication information is configured to indicate that an assistant terminal is allowed to participate in ranging/sidelink positioning between the first terminal and the second terminal, therefore the problem in which the ranging/sidelink positioning between two terminals cannot be performed when the two terminals cannot be directly connected with each other is overcome, and the ranging/sidelink positioning is performed with a lightweight signaling.

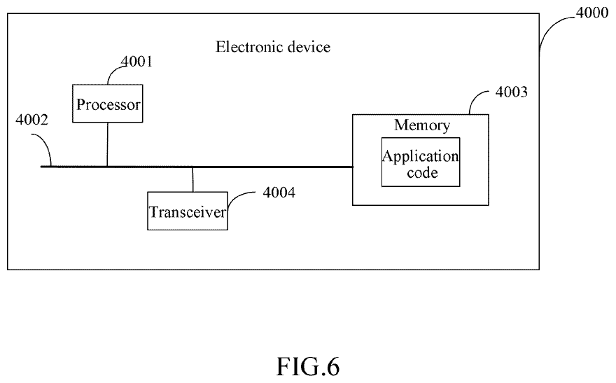

An embodiment provides an electronic device, and as shown in FIG. 6, the electronic device 4000 shown in FIG. 6 includes a processor 4001 and a memory 4003. The processor 4001 and the memory 4003 are connected, e.g., via a bus 4002. In an embodiment, the electronic device 4000 may also include a transceiver 4004, and the transceiver 4004 may be used for data interaction between the electronic device and other electronic devices, such as sending of data and/or receiving of data. It is to be noted that in practical application, the number of the transceiver 4004 is not limited to one, and the structure of the electronic device 4000 does not limit the embodiments of the present disclosure.

The processor 4001 may be a CPU (Central Processing Unit), a general-purpose processor, a DSP (Digital Signal Processor), an ASIC (Application Specific Integrated Circuit), FPGA (Field Programmable Gate Array) or other programmable logic device, a transistor logic device, a hardware component, or any combination thereof. It may implement or execute various logic blocks, modules, and circuits described in conjunction with the present disclosure. The processor 4001 may also be a combination that implements computing functions, such as a combination including one or more microprocessor, a combination of a DSP and a microprocessor, and the like.

The bus 4002 may include a path for transferring information between the components described above. The bus 4002 may be a PCI (Peripheral Component Interconnect) bus, an EISA (Extended Industry Standard Architecture) bus or the like. The bus 4002 may be divided into an address bus, a data bus, a control bus or the like. For ease of representation, only one thick line is shown in FIG. 6, which however does not mean that there is only one bus or one type of bus.

The memory 4003 may be a ROM (Read Only Memory) or other type of static memory device that can store static information and instructions, and a RAM (Random Access Memory) or other type of dynamic memory device that can store information and instructions, or may also be an EEPROM (Electrically Erasable Programmable Read Only Memory), CD-ROM (Compact Disc Read Only Memory) or other optical disk storage, optical disc storage (including compressed optical discs, laser discs, compact discs, digital general purpose discs, Blu-ray discs, etc.), magnetic disk storage media, other magnetic storage devices, or any other media capable of being carried or storing a computer program and capable of being read by a computer, which is not specifically limited herein.

The memory 4003 is used to store a computer program for executing the embodiment of the present disclosure and is controlled and executed by processor 4001. The processor 4001 is used to execute the computer program stored in the memory 4003 to implement the steps shown in the above method embodiments.

An embodiment of the present disclosure provides a computer-readable storage medium having a computer program stored thereon, and the computer program can be executed by a processor to implement the steps and corresponding contents of the foregoing method embodiments.

An embodiment of the present disclosure also provides a computer program product including a computer program, and the computer program can be executed by a processor to implement the steps and corresponding contents of the foregoing method embodiments.

The terms “first”, “second”, “third”, “fourth”, “1”, “2”, etc. (if any) in the specification and claims and the above-described figures of the present disclosure are used to distinguish similar objects and not to describe a particular order or sequence. It is to be understood that the data so used may be interchangeable, where appropriate, so that the embodiments of the present disclosure described herein can be implemented in an order other than that illustrated or described herein.

It is to be understood that although individual operating steps are indicated by arrows in the flowcharts of the embodiments of the present disclosure, the order in which these steps are implemented is not limited to the order indicated by the arrows. Unless explicitly stated herein, in some implementation scenarios of the embodiments of the present disclosure, the implementation steps in the respective flowcharts may be performed in other orders as desired. In addition, some or all of the steps in the respective flowcharts may include a plurality of sub-steps or a plurality of phases based on actual implementation scenarios. Some or all of these sub-steps or phases may be executed at the same moment, and these sub-steps or phases may be executed at different moments respectively. In a scenario where the execution moments are different, the execution order of these sub-steps or phases may be flexibly configured according to the demand, which is not specifically limited in the embodiments of the present disclosure.

The foregoing is only an implementation of some of the implementation scenarios of the present disclosure, and it is to be noted that without departing from the technical concept of the solution of the present disclosure, a person skilled in the art may adopt other similar implementation means based on the technical concept of the present disclosure, which also falls within the protection scope of the embodiments of the present disclosure.

1. A ranging/sidelink positioning method performed by a first terminal, comprising:
broadcasting a first ranging/sidelink positioning request, the first ranging/sidelink positioning request comprising first indication information,
wherein the first indication information indicates that an assistant terminal is allowed to participate in ranging/sidelink positioning between the first terminal and a second terminal.

2. The method according to claim 1, wherein the first indication information further indicates at least one candidate assistant terminal to return first response information to the first terminal based on discovering the second terminal.

3. The method according to claim 2, further comprising:
sending a second ranging/sidelink positioning request to at least one assistant terminal,
wherein the second ranging/sidelink positioning request comprises second indication information, and the second indication information is configured to authorize the candidate assistant terminal as the assistant terminal to participate in the ranging/sidelink positioning between the first terminal and the second terminal, and
the at least one assistant terminal is determined from the at least one candidate assistant terminal that returned the first response information.

4. The method according to claim 3, wherein the second indication information further indicates the assistant terminal to perform ranging/sidelink positioning with the first terminal, to initiate ranging/sidelink positioning to the second terminal, to perform the ranging/sidelink positioning with the second terminal, and to act as a relay for communication between the first terminal and the second terminal.

5. The method according to claim 4, further comprising:
responding to the ranging/sidelink positioning result,
wherein the ranging/sidelink positioning result is determined by at least one of the first terminal, the second terminal or the at least one assistant terminal based on the ranging/sidelink positioning measurement data shared.

6. The method according to claim 3, wherein the first indication information further indicates the second terminal to return second response information to the first terminal based on receiving the first ranging/sidelink positioning request.

7. The method according to claim 6, further comprising:
determining the at least one assistant terminal from the at least one candidate assistant terminal based on receiving the first response information from the at least one candidate assistant terminal and not receiving the second response information within a predetermined time period.

8. The method according to claim 7, wherein determining the at least one assistant terminal from the at least one candidate assistant terminal comprises:
using the candidate assistant terminal corresponding to the first response information firstly received as the assistant terminal.

9. The method according to claim 7, further comprising:
initiating ranging/sidelink positioning to the second terminal in response to receiving the second response information within the predetermined time period.

10. The method according to claim 7, wherein the predetermined time period is started at the time when the first ranging/sidelink positioning request is broadcast or the first response information sent by a first candidate assistant terminal is received.

11. A ranging/sidelink positioning method, performed by a third terminal, comprising:
receiving a first ranging/sidelink positioning request broadcast by a first terminal; and
determining to act as a candidate to participate in ranging/sidelink positioning between the first terminal and a second terminal based on predetermined authorization information indicating the third terminal to act as a candidate assistant terminal, and first indication information in the first ranging/sidelink positioning request.

12. The method according to claim 11, further comprising:
returning first response information to the first terminal based on discovering the second terminal.

13. The method according to claim 11, further comprising:
determining the third terminal itself to be the second terminal, and returning second response information to the first terminal.

14. The method according to claim 12, further comprising:
receiving a second ranging/sidelink positioning request sent by the first terminal, and determining to participate in the ranging/sidelink positioning between the first terminal and the second terminal based on second indication information in the second ranging/sidelink positioning request.

15. The method according to claim 14, further comprising:
based on the second indication information, performing ranging/sidelink positioning with the first terminal, initiating ranging/sidelink positioning to the second terminal, performing the ranging/sidelink positioning with the second terminal, and acting as a relay for communication between the first terminal and the second terminal.

16. The method according to claim 15, wherein initiating the ranging/sidelink positioning to the second terminal comprises:
sending a third ranging/sidelink positioning request to the second terminal, the third ranging/sidelink positioning request comprising the second indication information.

17. The method according to claim 12, further comprising:
determining that the second terminal is discovered based on having searched the second terminal in a maintained list of terminals.

18. The method according to claim 17, further comprising:
triggering a process for discovering the second terminal based on not searching the second terminal in the list of terminals; and
recording a unique identifier of the second terminal in the list of terminals [when]in response to discovering the second terminal.

19. The method according to claim 11, further comprising:
sending third indication information to a policy control function entity, the third indication information indicating that the third terminal has a capability of acting as an assistant terminal to participate in ranging/sidelink positioning between two terminals; and
receiving authorization information returned by the policy control function entity, the authorization information indicating that the third terminal is allowed to act as a candidate assistant terminal to participate in the ranging/sidelink positioning.

20-21. (canceled)

22. An electronic device applied to a first terminal, comprising a memory, a processor and a computer program stored on the memory, wherein the computer program, when being executed by the processor, causes the first terminal to implement actions comprising:
broadcasting a first ranging/sidelink positioning request, the first ranging/sidelink positioning request comprising first indication information,
wherein the first indication information indicates that an assistant terminal is allowed to participate in ranging/sidelink positioning between the first terminal and a second terminal.

23. (canceled)
